(19) United States
(12) Patent Application Publication
(10) Pub. No.: US 2003/0135420 A1
(43) Pub. Date: Jul. 17, 2003

(54) Web-based method for managing and communicating information regarding an order of consumer goods

(76) Inventors: Nicholas A. Culling, Devon, PA (US); Sarah Osbourne, Louisville, KY (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 10/042,859

(22) Filed: Jan. 11, 2002

(51) Int. Cl. G06F 17/60

(52) U.S. Cl. 705/26

(57) ABSTRACT

A Web-based method for managing and communicating information regarding an order of consumer goods is provided. The method allows to store order data in a data base. The order data includes at least one identifier associating a respective order to a respective consumer. The method enables an authorized requester to retrieve order data that matches the identifier. A Web page is provided that includes one or more data fields indicative of the status of the order. The Web page further includes a menu of choices for enabling the requester to input new data for that order. The new data is generally indicative of new requests the consumer may have regarding that order.

### BACKGROUND OF THE INVENTION

This invention is generally related to a Web-based method, and more particularly to a Web-based method for managing and communicating information regarding an order of consumer goods.

It is known that at least one other company has employed an Internet-based goods delivery system wherein the goods can be ordered from one particular store and delivered to a designated buyer's address. For example, Home Depot Company has employed an Internet-based appliance delivery system that enables the buyer to place an Internet-based order for a brand of goods, and the respective goods be delivered to the buyer's designated address. Once the order is placed, the order is sent to a respective delivery agent via the Internet. The respective delivery agent then delivers the respective goods. Unfortunately, this delivery system suffers from a number of disadvantages. For example, such system could not automatically generate order reschedules resulting from a variety of events that may occur during the delivery process, such as “refusal”, “cancellation”, “damaged” goods, “delays” and “shortages.”

Other delivery management systems that are known provide Internet-based delivery of standard size packages. One example is the Federal Express® goods delivery system. As used herein, non-standard size packages are packages that are generally not delivered by air carriers and mail delivery services, and typically are packages that weigh over about 100 lbs. (45 kg). The delivery of non-standard size packages generally requires a delivery agent who is equipped to ship and install the delivered goods. For example, there presently exists several appliance delivery services that receive the appliance from the appliance manufacturer, deliver, and, optionally, install the appliance after the purchaser has ordered the appliance from a local appliance store. This entire operation is manually executed based on a delivery manifest. The delivery manifest is typically a document identifying the delivery agents goods shipment schedule. U.S. patent application, 9D-EC-19310, titled “Internet-based Goods Delivery System”, assigned to the same assignee of the present invention and herein incorporated by reference, provides an innovative and valuable system and method for the delivery of non-standard size goods that minimizes direct human contact between the buyer, the supplier, and the delivery agent. It is desirable to further improve Web-based techniques for managing and communicating information regarding an order of consumer goods. For example, it would be desirable to provide techniques that, in addition to enabling a requester of information to quickly and reliably determine the status of any specific order, would also allow the requester to have access to a menu of choices that will enable the requester to input new data for the order. The new data could be used to indicate new requests that the consumer may have in connection with the order of the goods and/or in connection with services associated with such goods.

### BRIEF SUMMARY OF THE INVENTION

Generally, one aspect of the present invention, fulfills the foregoing needs by providing a Web-based method for managing and communicating information regarding an order of consumer goods. The method allows to store order data in a data base. The order data includes at least one identifier associating a respective order to a respective consumer. The method enables an authorized requester to retrieve order data that matches the identifier. A Web page is provided that includes one or more data fields indicative of the status of the order. The Web page further includes a menu of choices for enabling the requester to input new data for that order. The new data is generally indicative of new requests the consumer may have regarding that order.

### DESCRIPTION OF THE DRAWINGS

FIG. 1 illustrates an exemplary schematic representation of a system that may be used for practicing a Web-based method in accordance with one aspect of the present invention.

FIG. 2 illustrates an exemplary flowchart of a Web-based method for managing and communicating information regarding an order, e.g., an E-commerce order placed by a consumer in an E-store.

FIG. 3 illustrates an exemplary flow chart of a process as may be implemented by a representative of a retailer that supplies consumer goods.

FIG. 4 is Web page representation of an exemplary order tracking screen for E-commerce orders that includes data fields for displaying the status of a given order and including a menu of choices for entering new order data.

FIG. 5 is Web page representation of an exemplary order tracking screen for retailer orders.

Before any embodiment of the invention is explained in detail, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

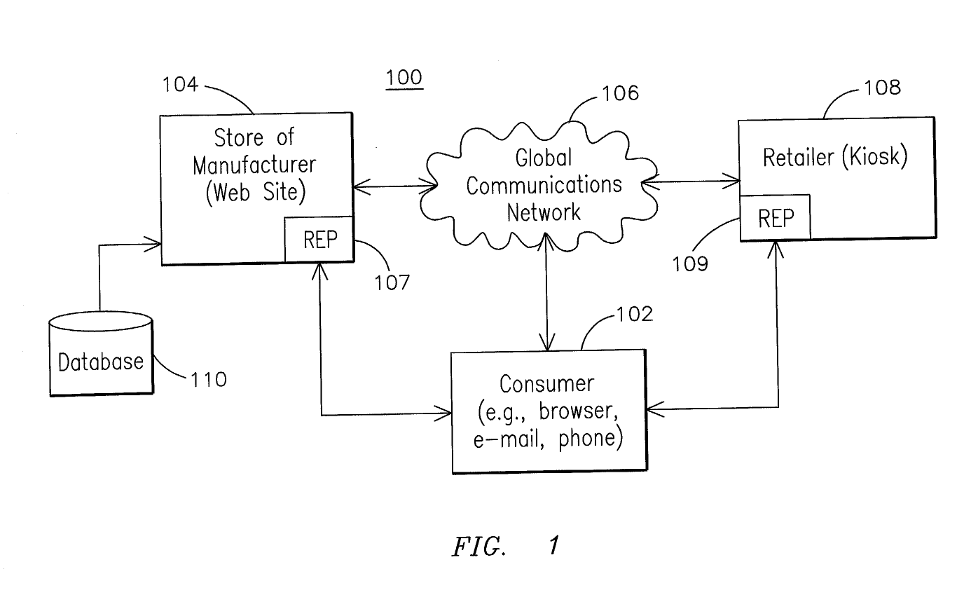

FIG. 1 illustrates an exemplary schematic representation of a system 100 that may be used for practicing a Web-based method for managing and communicating information regarding an order of consumer goods and/or services in connection with the goods. System 100 includes devices that cooperate in a manner that, in one exemplary embodiment, allows for seamlessly integrating a logistical supply chain through a global communication network 106, such as the Internet, using commercially available browsers, and Internet-based applications. By way of example, the logistical supply chain may comprise consumer purchasers of goods, a seller manufacturer of the goods, such as the GE Appliances business organization of the assignee of the present invention, retailers of the goods such as Walmart stores, and other intermediaries that may facilitate the delivery of the goods from the manufacturer to the residence of the consumer. System 100 allows a consumer desiring to access an E-commerce store, e.g., a Web site 104, of the manufacturer where various consumer goods, such as appliances, entertainment electronics, etc., may be purchased by the consumer using well-known E-commerce purchasing techniques. As suggested above, communication between consumer 102 and Web site 104 may take place through the Internet. The present invention is not limited however to direct E-commerce transactions since it is contemplated that in some embodiments of the present invention a purchasing transaction could take place via a representative of the manufacturer, e.g., representative 107. The communication between the consumer and the representative of the manufacturer could take place by any suitable communication means, such as e-mail, fax, telephonic communication, etc. Thus, it will be appreciated that the order of the consumer goods and/or services in connection with those goods may occur through various ordering modes. For example, as suggested above, one ordering mode would be for the consumer to directly place the order via an E-commerce transaction. Another ordering mode would be for the consumer to place the order through a representative of the manufacturer, such as call taker. In yet another mode of ordering the goods, consumer 102 could order the goods through a retailer 108. In this case, communications regarding the order could be supplied via an electronic kiosk operated by a representative of the retailer, e.g., representative 109.

In one exemplary embodiment, the kiosk is configured to access Web site 104 through global communications network 106. In one key advantage of the invention, a data base 110 may be used for storing order information, regardless of the order mode. This is particularly helpful since regardless of the order mode, a requester of information would be able to quickly and reliably learn of the status of the order. Further, the order data, as stored in data base 110, is believed to more freshly or up-to-date indicate the status of the information since it would track the order right from its originating source, that is, right from the manufacturer of the goods. As further described below, the requester would be able to input new data that may indicate new requests that the consumer may have in connection with the order. It is contemplated that generally the requester of information could be the consumer, the representative of the manufacturer, or the representative of the retailer. For example, the consumer may be following up regarding an order she directly placed with the manufacturer's store Web site 104. In another example, the consumer may be following up with the representative of the manufacturer, e.g., the call taker, and making an inquiry with the call taker regarding the status of the order she placed through a phone call. In this example, the requester of the order information would be the call taker so that essentially in real time the consumer would be apprised by the representative of the manufacturer of the latest status of her order. In yet another example, the consumer may be following up with the representative of the retailer in connection with the status of an order she placed with the retailer. In this case, the retailer representative, once again, essentially in real time, would be able to assist the consumer by requesting order information from data base 110 through a web-based kiosk, for example. As suggested above, the method allows to store and/or update the order data in data base 110. The order data includes at least one identifier that associates a respective order to a respective consumer. The method enables an authorized requester to retrieve order data that matches the identifier provided by the requester. The method provides a Web page including one or more data fields indicative of the status of the order. The Web page further includes a menu of choices for enabling the requester to enter new data for the order. For example, the new data may be indicative of new requests the consumer may have regarding the order or orders placed by that consumer.

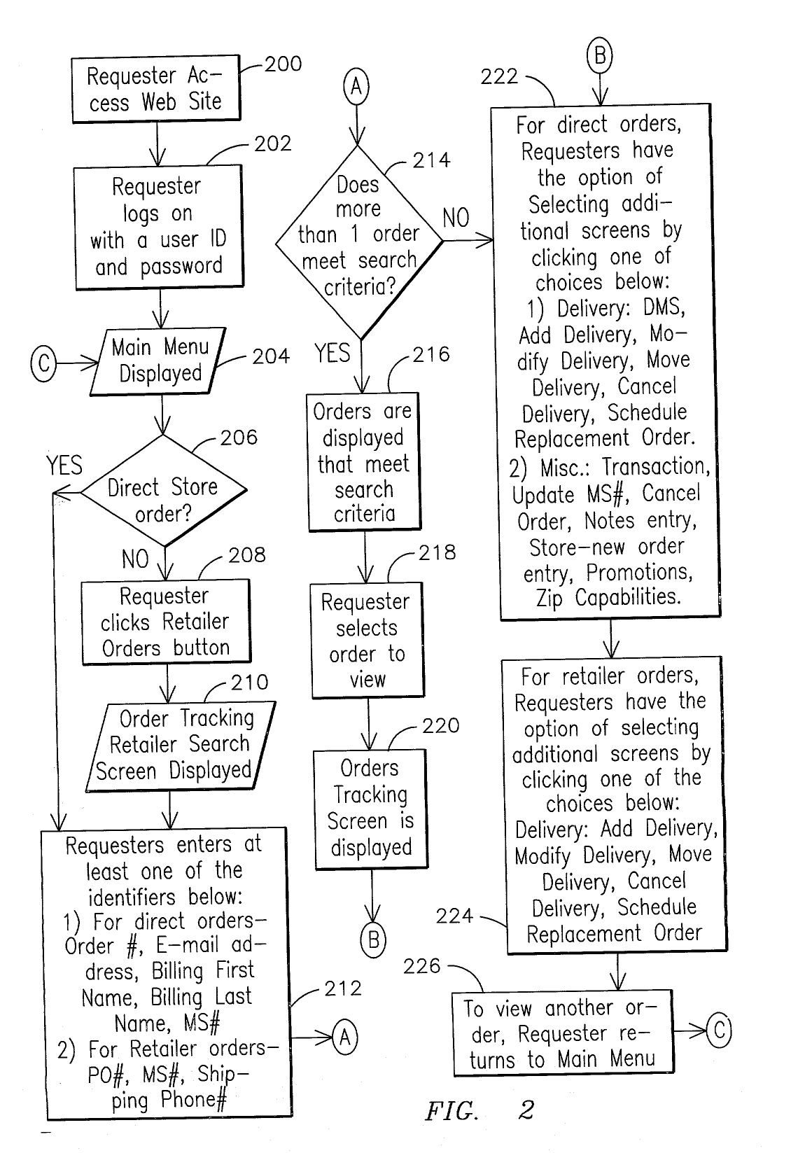

FIG. 2 illustrates an exemplary flowchart of a Web-based method for managing and communicating information regarding a given order, e.g., an E-commerce order, of consumer goods and/or services. As shown in FIG. 2, at block 200 the requester, e.g., the representative of the manufacturer or call taker, accesses Web site 104 (FIG. 1) in response to an inquiry from a given consumer. As shown at block 202, the requester logs on using a suitable user I.D. and password. At block 204, a main menu is displayed. Decision block 206 allows to verify or determine whether or not the order is of a type directly placed by the consumer with the manufacturer's store, such as may have occurred during a standard e-commerce order. If at decision block 206 is determined that an order is a direct store order, then block 212 allows the requester to enter at least one identifier, such as purchase order number, e-mail address, billing first name, billing last name, manufacturer's internal tracking number (MS).

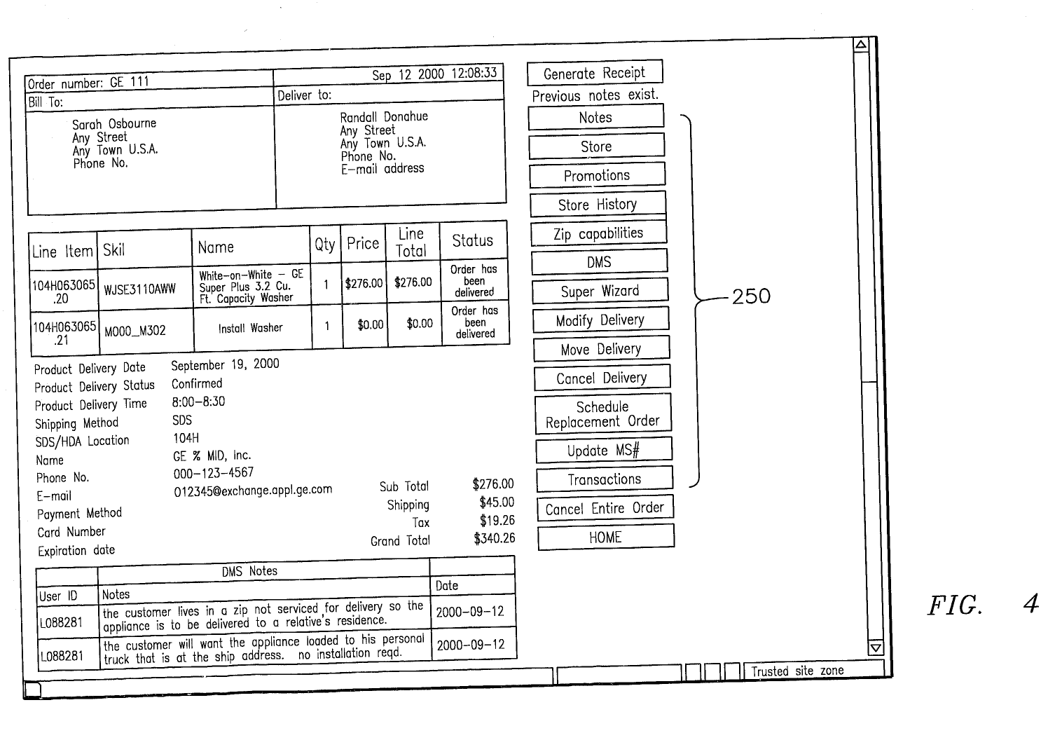

In the event that the type of order is of the type generated by a purchase from a retailer, then as shown at block 208, the requester will click a retailer orders button. Block 210 allows to display an order tracking retailer search screen that allows the requester to enter a suitable identifier, such as purchase order number, manufacturer internal tracking number, or shipping phone number. As shown in block 214, if there is more than one order that meets the search criteria, then as shown in block 216, all such orders will be displayed. As shown in block 218, the requester would then select a specific order to view, based on other distinguishing factors that may be provided by the consumer, such as the date the order was placed, quantity, etc. As shown at block 220, the order tracking screen will be displayed. An example of the order tracking screen for E-commerce orders is illustrated in FIG. 4.

As shown at block 222, a menu of choices is displayable to the requester based on the order mode, that is, whether the order is a direct store order or whether the order is an order processed by a retailer. A Web page representation illustrating an exemplary menu of choices 250 available for an E-commerce order is illustrated in FIG. 4. In its present configuration, the menu of choices available to retailer orders is somewhat narrower than the menu of choices available to direct orders. It is contemplated however that, assuming appropriate security provisions were to be implemented, the number of choices available to retailers could conceptually become essentially analogous to those available for E-commerce orders, e.g., orders directly placed into the manufacture's store Web site. As will be appreciated by those skilled in the art, the security provisions would avoid unintended errors, such as could occur if a retailer from Walmart stores, for example, were to unintentionally modify orders from the customers of another retailer chain.

Regardless of the type of order, the requester has the option of selecting additional screens by clicking one of several links, such as hyperlinks. Example of the screens that may be available to the requester may comprise screens that enable the requester to input new data for the order, where such new data may indicate new requests the consumer may have regarding the order, such as add delivery, modify delivery, move delivery, cancel delivery, replace an order, update the manufacturer tracking number, cancel order, entry of notes in connection with an order, information regarding promotions, zip code functionality, etc.

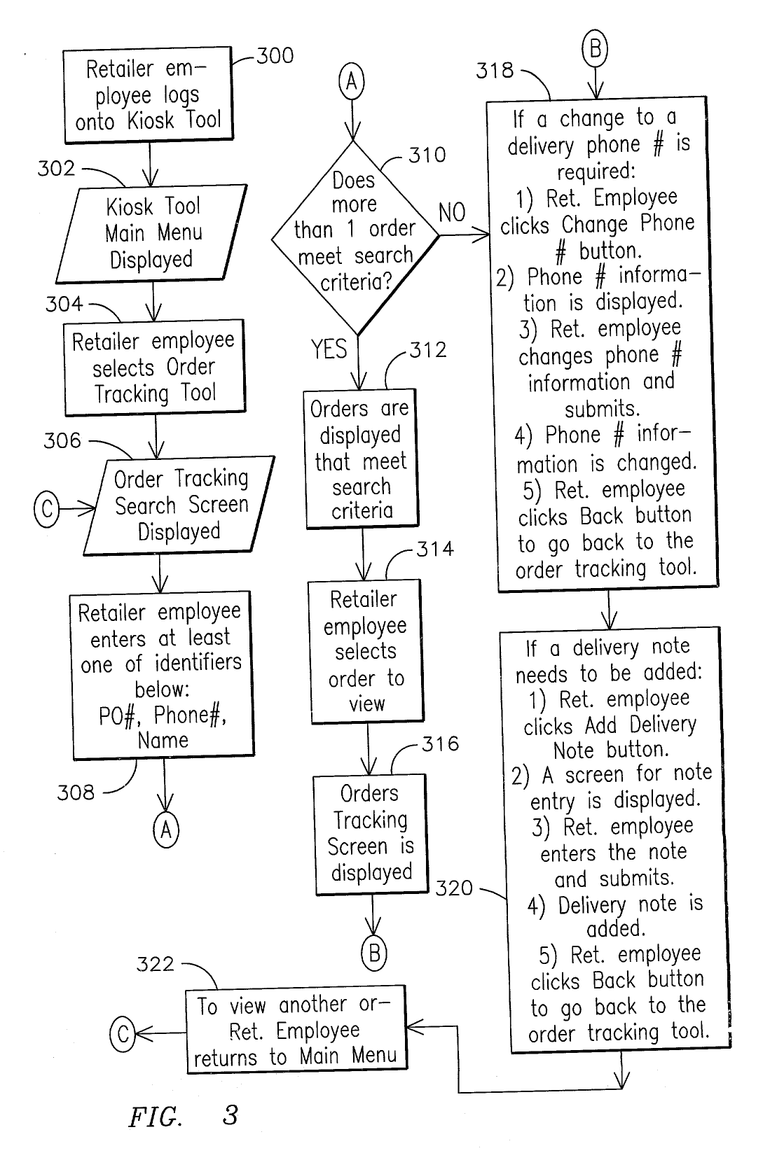

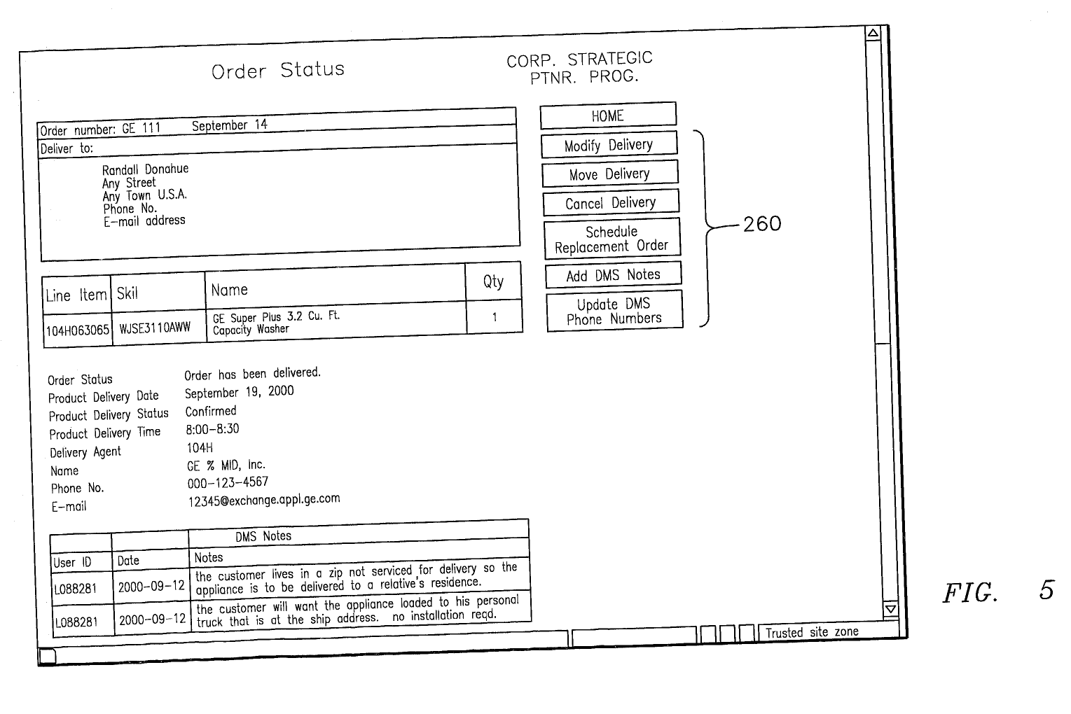

As suggested above and as shown in block 224, the menu of choices available to a requester who is a representative of the retailer of the consumer goods may comprise a subset of the menu of choices available to the requester who is a representative of the manufacturer of the consumer goods. A Web page representation illustrating an exemplary subset of choices 260 available in a retailer order is shown in FIG. 5. The subset of choices may provide to the requester links for selecting additional screens, such as add delivery, modify delivery, move delivery, cancel delivery, and schedule of replacement order, such as may be needed in the event the goods may have become damaged during shipment. Block 226 allows the requester to view another order by enabling the requester to return to the main menu. FIG. 3 illustrates an exemplary flow chart of a process as may be implemented by a representative of a retailer that supplies consumer goods. As shown at block 300, the retailer employee logs onto the Web-enabled kiosk. Block 302 allows the kiosk to display its main menu. Block 304 allows the retailer employee to select the order tracking tool. Block 306 allows to display the order tracking search screen. An example of the order tracking screen for retailer order is illustrated in FIG. 5. Block 308 allows the retailer employee to enter at least one identifier, such as purchase order number, phone number of the consumer purchaser, name, etc. Block 310 allows to as determine whether there is more than one order that meets the search criteria. Block 312 allows for displaying each order that meets the search criteria. Block 314 allows the retailer employee to select any given order to view. Block 316 displays the order tracking screen. Blocks 318 and 320 respectively allow for modifying some of the order data previously supplied by the customer to the retailer, such as changing a delivery phone number in the event the customer requires such a change. For example, block 318 may allow the retailer employee to click an icon for changing the phone number originally provided by the consumer. Block 320 allows to add a delivery note for summarizing a request of the customer or information that the customer may have provided to the representative of the retailer in connection with the order placed by that customer. Block 322 allows the retailer employee to return to the main menu screen.

The present invention can be embodied in the form of computer-implemented processes and apparatus for practicing those processes. The present invention can also be embodied in the form of computer program code including computer-readable instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. When implemented on a computer, the computer program code segments configure the computer to create specific logic circuits or processing modules.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. A Web-based method for managing and communicating information regarding an order of consumer goods, said method comprising:
storing order data in a data base, said order data including at least one identifier associating a respective order to a respective consumer;
enabling an authorized requester to retrieve order data that matches said at least one identifier; and
providing a web page including one or more data fields indicative of the status of said order, said web page further including a menu of choices for enabling said requester to input new data for said order, said new data generally indicative of new requests the consumer may have regarding said order.

2. The Web-based method of claim 1 further comprising determining a respective order mode of the order associated with the retrieved order data.

3. The Web-based method of claim 2 wherein the menu of choices displayable to the requester is based on the determined order mode.

4. The Web-based method of claim 1 wherein the consumer goods comprise appliances.

5. The Web-based method of claim 4 wherein the requester comprises a representative of the manufacturer of the appliances.

6. The Web-based method of claim 1 wherein the requester is the consumer.

7. The Web-based method of claim 4 wherein the requester comprises a representative of a retailer of the appliances.

8. The Web-based method of claim 2 wherein the order mode indicates whether the order was directly submitted to the manufacturer of the consumer goods by the consumer, or whether the order was submitted through a retailer of the consumer goods.

9. The Web-based method of claim 1 wherein the order data further includes information for services purchased in connection with the consumer goods.

10. The Web-based method of claim 3 wherein the menu of choices available to a requester who is a representative of a retailer of the consumer goods is a subset of the menu of choices available to a requester who is a representative of the manufacturer of the consumer goods.

11. A computer-readable medium encoded with computer program code for managing and communicating information thorough a global communications network, said information regarding an order of consumer goods, the program code causing a computer to execute a method comprising:
storing order data in a data base, said order data including at least one identifier associating a respective order to a respective consumer;
enabling an authorized requester to retrieve order data that matches said at least one identifier;
determining a respective order mode of the order associated with the retrieved order data; and
providing a web page including one or more data fields indicative of the status of said order, said web page displaying a menu of choices for enabling said requester to input new data for said order, wherein the menu of choices displayable to the requester is based on the determined order mode.

12. The computer-readable medium of claim 11 wherein the consumer goods comprise appliances.

13. The computer-readable medium of claim 12 wherein the requester comprises a representative of the manufacturer of the appliances.

14. The computer-readable medium of claim 13 wherein the requester comprises the consumer.

15. The computer-readable medium of claim 14 wherein the requester comprises a representative of a retailer of the appliances.

16. The computer-readable medium of claim 15 wherein the order mode indicates whether the order was directly submitted to the appliance manufacturer by the consumer, or whether the order was submitted through the retailer of the consumer goods.

17. The computer-readable medium of claim 11 wherein the order data further includes information for services purchased in connection with the consumer goods.

18. The computer-readable medium of claim 11 wherein the menu of choices available to a requester who is a representative of a retailer of the consumer goods is a subset of the menu of choices available to a requester who is a representative of the manufacturer of the consumer goods.
